(19) United States
(12) Patent Application Publication
(10) Pub. No.: US 2008/0048506 A1
(43) Pub. Date: Feb. 28, 2008

(54) Electromotive device

(76) Inventor: David G. Deak, Brooklyn, NY (US)

Correspondence Address: COOPER & DUNHAM, LLP, 1185 AVENUE OF THE AMERICAS, NEW YORK, NY, 10036, US

(21) Appl. No.: 11/890,112

(22) Filed: Aug. 3, 2007

Related U.S. Application Data
(60) Provisional application No. 60/835,314, filed on Aug. 3, 2006.

(51) Int. Cl. H02K 21/00

(52) U.S. Cl. 310/12

(57) ABSTRACT

An electromotive device, operable in either a generator or motor mode, comprises a coil assembly and magnets, wherein a mechanical force and a magnetic force combine to move a driver magnet relative to an electrical coil. In one embodiment the device provides a batteryless, wireless switch controller.

The present invention relates to electromotive devices operable as either a motor or generator, and in one preferred arrangement to a batteryless, wireless switch controller operating in a generator mode for controlling power to an electrical device such as a light remotely and wirelessly.

Various electromotive devices have been proposed which may operate in a motor or generator mode. Many of them are complicated, have many moving parts such as rotors, stators and wire coils. The expense and complicated structure of these devices has prevented their use to many applications which would otherwise benefit from such a use.

For example, electromotive devices operating as generators have been used as switch controllers to control appliances such as lights in a room or premises. They have used piezoelectric elements which are sometimes expensive and not simple to make.

There is a need for an electromotive device operable in both motor and generator modes which is simple to make, has few moving parts, and is inexpensive.

There is also a need for a batteryless, wireless switch controller which is likewise simple in design, has few moving parts, is inexpensive so that it would be widely used and adopted, and can be used in original construction and retrofit control applications.

### SUMMARY OF THE INVENTION

It is an object of the present invention to provide an electromotive device usable in both motor and generator modes.

It is an object of the present invention to provide an electromotive device which is simple to make, has few moving parts, and is relatively inexpensive.

It is an object of the present invention to provide an electromotive device usable as a wireless, batteryless switch controller.

The present invention provides an electromotive device operable as a motor/generator for converting energy between a mechanical form and an electrical form, comprising: a tube member having a hollow center, and having a driver magnet slideable within the hollow center, said tube member having and opening generally in the center of the tube member; a paddle connected to the driver magnet and extending through the opening in the tube member, a wire coil wound along at least part of the length of the tube member and having two coil ends; first and second tube magnets, each tube magnet mounted near a different end of the tube member, said driver magnet and tube magnets oriented in their magnet fields to oppose the driver magnet from the ends of the tube member; a rocker having a pivot point and first and second ends, and having a first rocker magnet at the first end of the assembly and a second rocker magnet at the second end of the assembly, said rocker adapted to pivot about a pivot point between a first position wherein the first rocker magnet is positioned closer to the tube member, and a second position wherein the second rocker magnet is positioned closer to the tube member, wherein during pivot movement between the first and second positions, the driver magnet slides within the tube, by engagement of the paddle with the rocker assembly and by magnetic forces between the driver magnet and clamp magnets; wherein the device is operable as a generator for generating a voltage across the two coil ends when the rocker is moved between the first and second positions, and wherein the device is operable as a motor for moving the rocker between first and second position when a voltage is applied across the two coil ends.

The present invention also provides an electromotive device operable as a motor/generator for converting energy between a mechanical form and an electrical form, comprising: a tube member having a hollow center, and having a driver magnet slideable within the hollow center, said tube member having and opening generally in the center of the tube member; a paddle connected to the driver magnet and extending through the opening in the tube member, a wire coil wound along the length of the tube member and having two coil ends; first and second tube magnets, each tube magnet mounted on a different end of the tube member, said driver magnet and tube magnets oriented in their magnet fields to oppose the driver magnet from the ends of the tube member; a rocker having a pivot point and first and second ends, and having a first rocker magnet at the first end of the assembly and a rocker clamp magnet at the second end of the assembly, said rocker adapted to pivot about a pivot point between a first position wherein the first rocker magnet is positioned closer to the tube member, and a second position wherein the second rocker magnet is positioned closer to the tube member, wherein during pivot movement between the first and second positions, the driver magnet slides within the tube, by engagement of the paddle with the rocker assembly by magnetic forces between the driver magnet and rocker magnets; wherein the device is operable as a generator for generating a voltage across the two coil ends when the rocker moves between the first and second positions, and wherein the device is operable as a motor for moving the rocker between first and second position when a voltage is applied across the two coil ends; wherein the rocker assembly comprises a rocker housing with a lower left clamp magnet and a lower right clamp magnet, and a rocker element adapted to pivot with respect to the rocker housing and having an upper left rocker magnet and a upper right rocker magnet, said upper left rocker magnet positioned closer to the first tube magnet when the rocker element is in a second position; and wherein the device includes a circuit connected to the ends of the coil for generating and transmitting a switching signal in response to a sufficient voltage appearing across the coil and a current flowing through the coil.

The present invention also provides an electromotive device for converting energy from a mechanical form to an electrical form comprising: an electrical coil having two ends; a driver magnet moveable within the electrical coil; means for mechanically moving the driver magnet relative to the electrical coil; means for magnetically moving the driver magnet relative to the electrical coil; said means for mechanically moving and means for magnetically moving the driver magnet combining to move the driver magnet relative to the electrical coil in the same direction at the same time.

### BRIEF DESCRIPTION OF THE DRAWINGS

FIG. 1 is a perspective view of one embodiment of the invention used as a batteryless, wireless switch;

FIG. 2 is a perspective view of the switch box portion of FIG. 1;

FIG. 3 is a perspective view of the rocker base of FIG. 1;

FIG. 4 is a perspective view of the rocker which operates with the rocker base of FIG. 3;

FIG. 5 is a perspective view of the rocker of FIG. 4, from a different perspective of that in FIG. 4;

FIG. 6 is a perspective view of the rocker and rocker base together;

FIG. 7 is a perspective view of the flicker support component of the embodiment of FIG. 1;

FIG. 8 is a perspective view of the magnet sleeve component of the embodiment of FIG. 1;

FIG. 9 is a perspective of the flicker support with magnets sleeve installed;

FIG. 10 is a side elevational view, in cross section, of the embodiment of FIG. 1.

FIG. 11 is a side elevational view of the flicker support with a coil wound around;

FIG. 12 is a block diagram of a transmitter circuit connected to the coil for using the devices as a batteryless wireless switch controller;

FIG. 13 is a block diagram of a receiver circuit used with the transmitter circuit of FIG. 12;

FIG. 14 shows the relative position of all of the magnets when the rocker switch is in one position; and

FIG. 15 shows the relative position of all of the magnets when the rocker switch is in the opposite position from that in FIG. 14.

### DESCRIPTION OF A PREFERRED EMBODIMENT

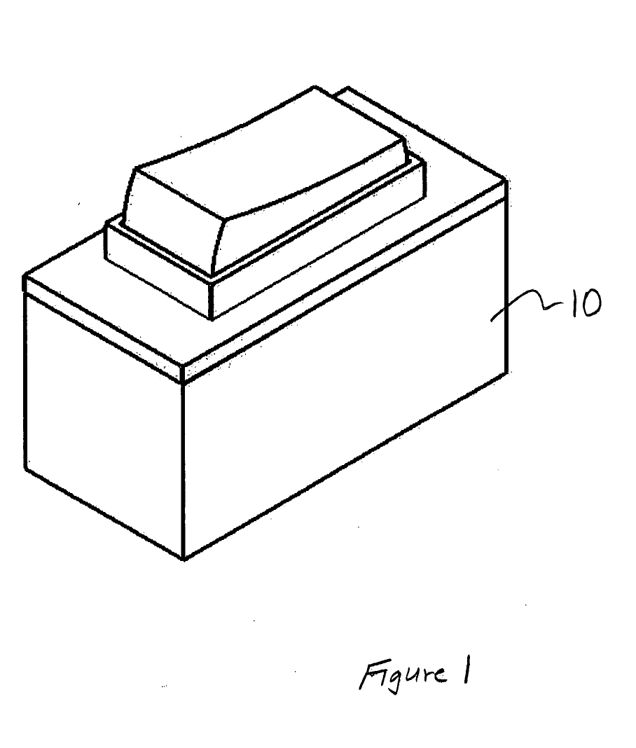

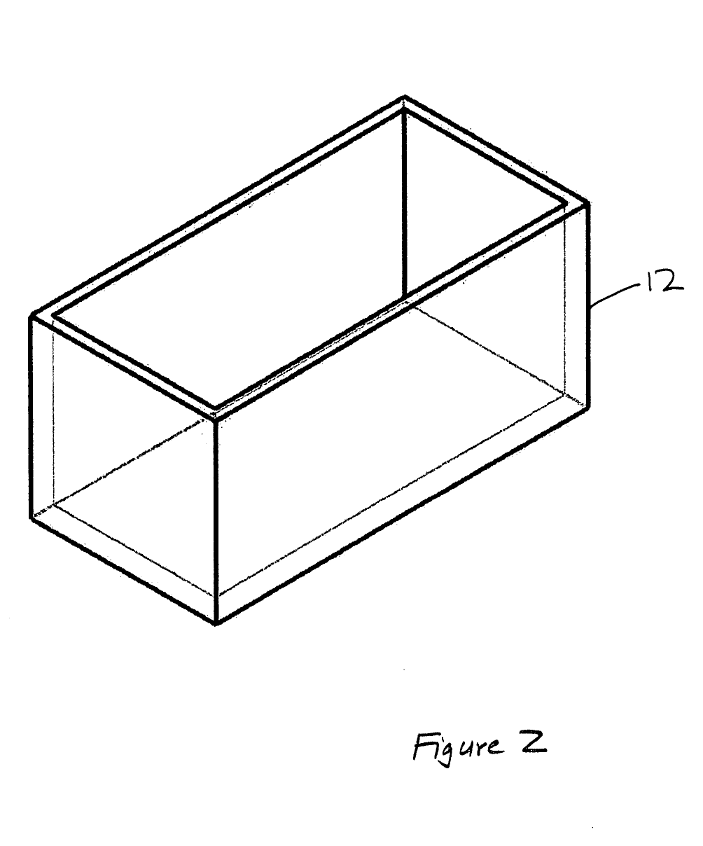

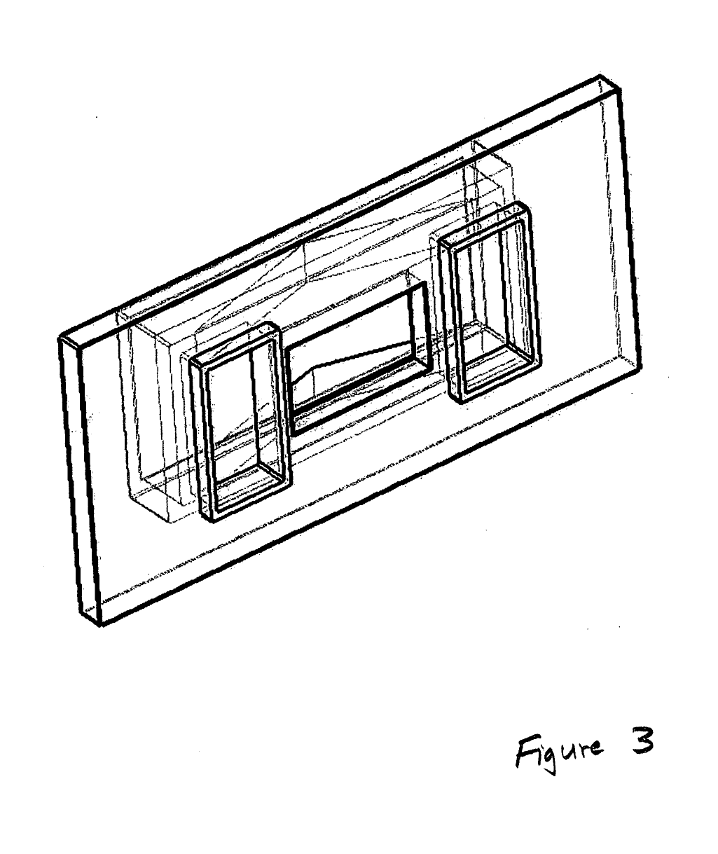

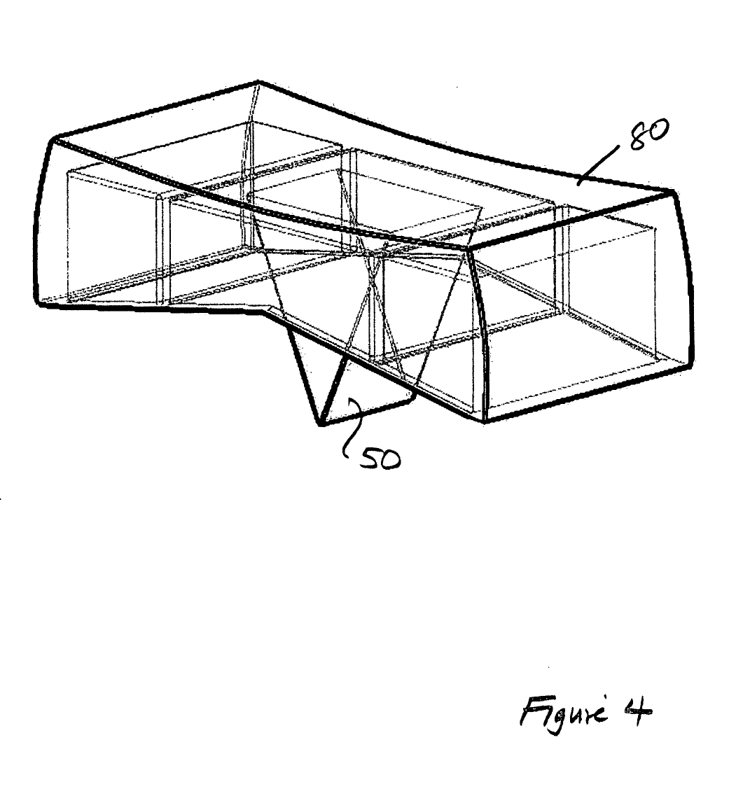

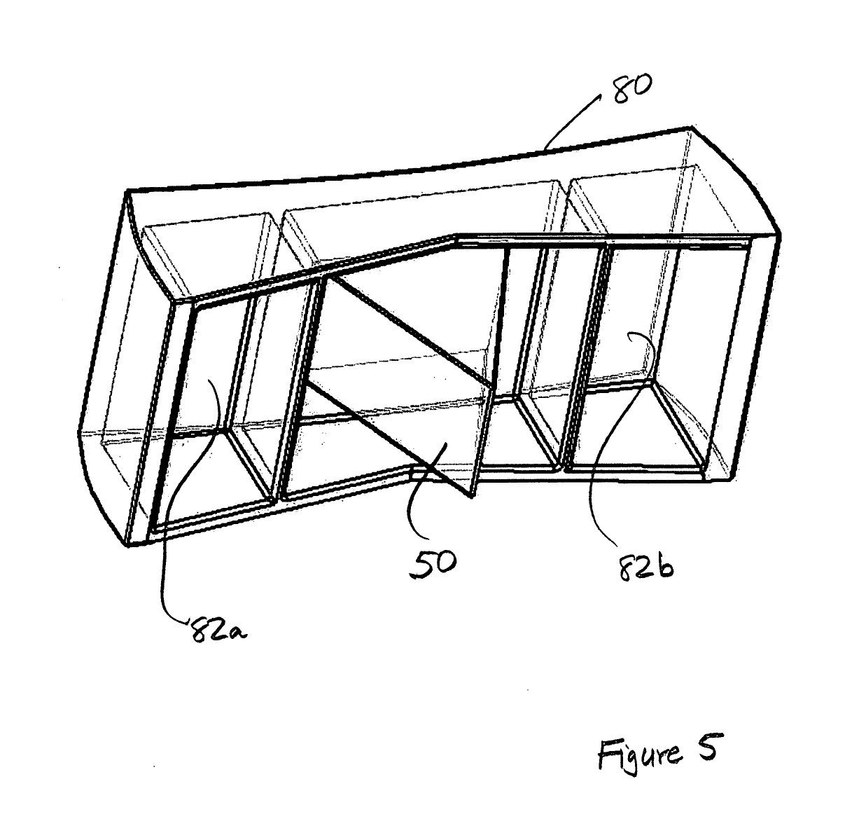

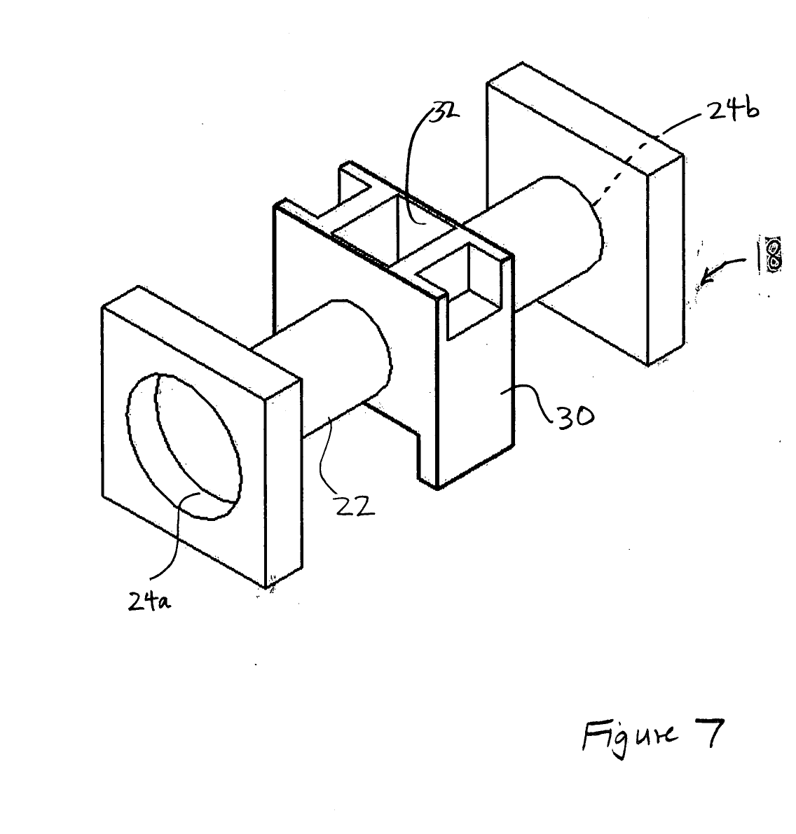

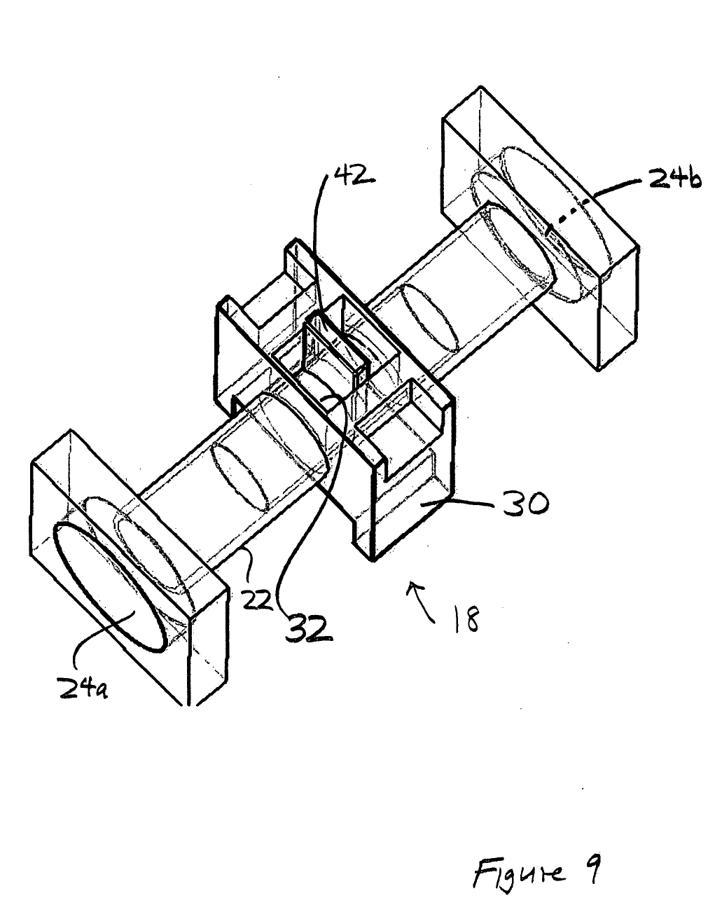

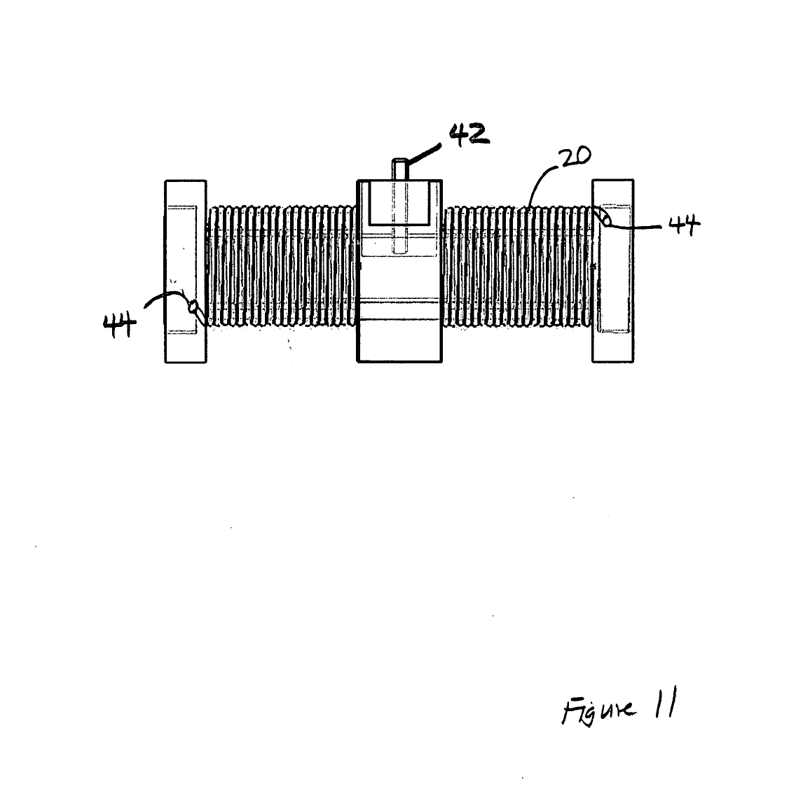

FIG. 1 shows a perspective view of an embodiment of an electromotive device 10 according to the invention. The device generally includes a switch box 12 (FIG. 2), a rocker assembly 14 (FIGS. 3, 4, 5 and 6), a driver magnet assembly 16 and a tube member (flicker support) 18 for receiving the driver magnet assembly wherein the driver magnet may slide through the inside of wire coils 20 wound around the tube member (FIGS. 7, 8, 9, 10 and 11. Magnets, preferably in the form of high field magnets such as neo-dymium magnets, are also provided in the rocker assembly and tube member and serve to increase the motor or generator effect, as the case may be, when the device is operated in a motor or generator mode.

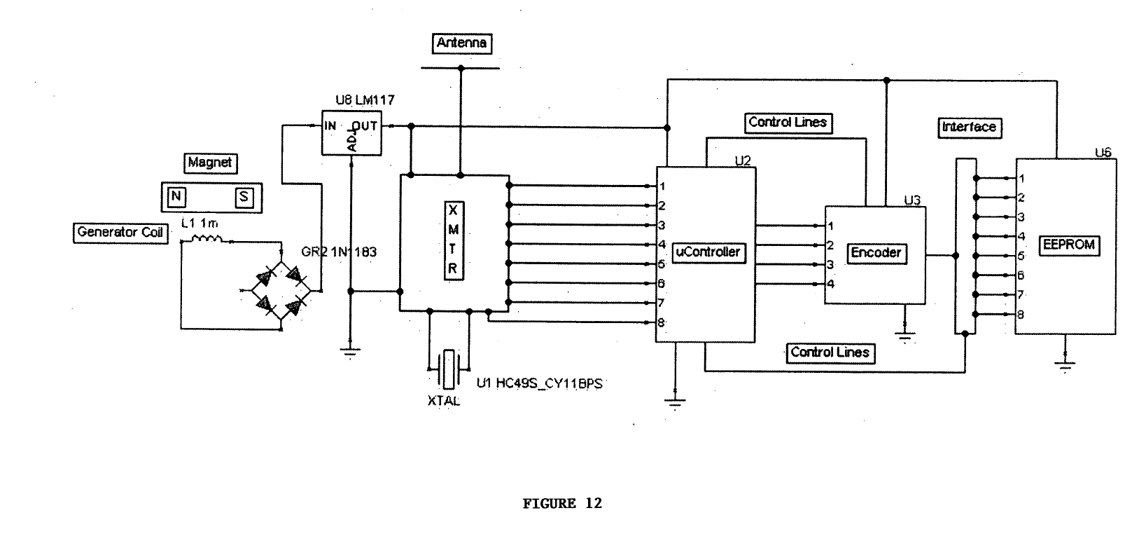

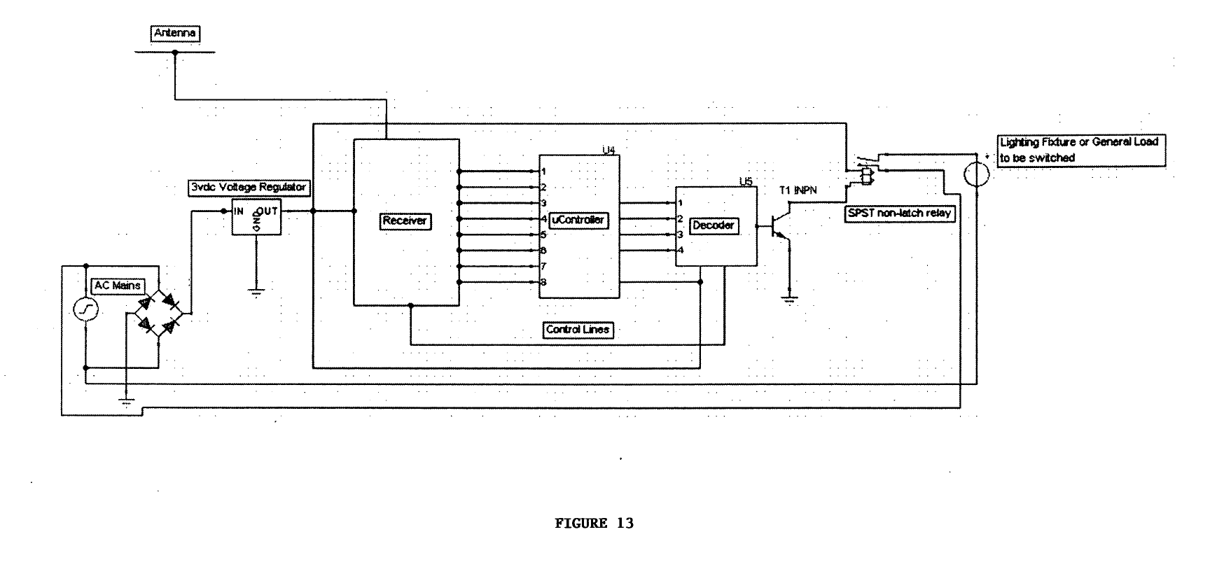

The device according to an embodiment of the invention has particular use and application as a batteryless, wireless switch controller for controlling power to electrical appliances such as lights in a building structure such as a residence or other premises using the circuitry of FIGS. 12 and 13. The embodiment will be described mainly in conjunction with such an application as a switch controller operating in a generator mode, but the invention is not so limited in its scope and application.

The device advantageously is capable of producing sufficient voltage and current to drive a transmitter circuit to produce a transmitter signal suitable for remotely controlling a light or other appliance, and may be thought of as a wireless, batteryless relay controller.

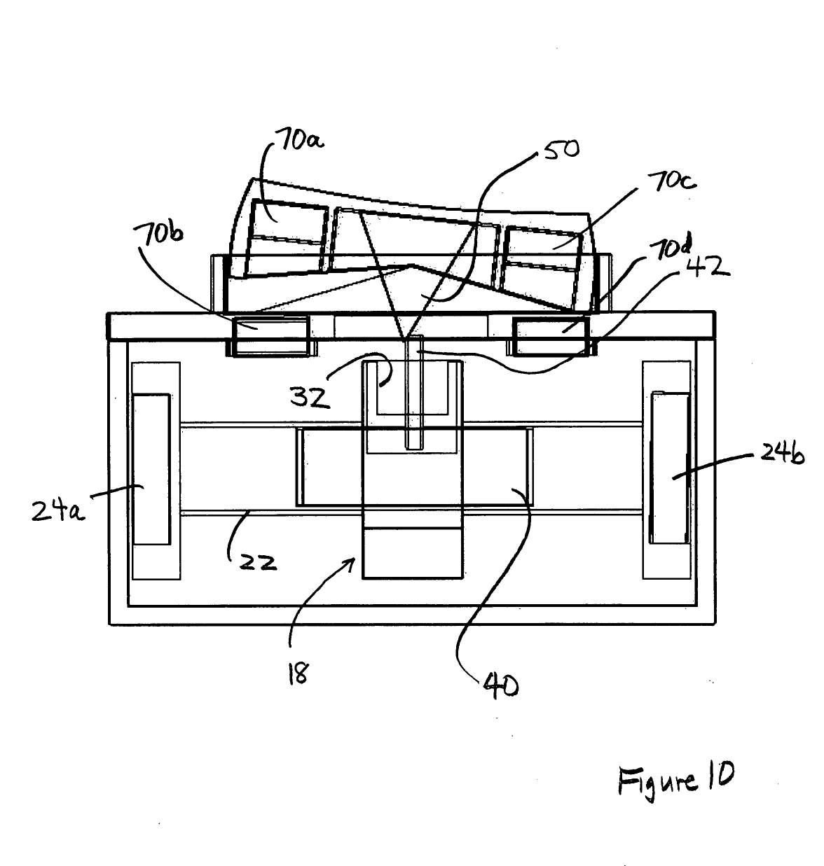

FIG. 10 shows an embodiment of an electromotive device according to the invention in an elevational, cut-away view. The device 10 includes a tube member assembly 18 having a tube member or “chunnel” 22 with a hollow core. At each end of the tube member is a tube magnet 24a, 24b. Both the rightmost tube magnet and leftmost tube magnet are arranged to have their south poles facing to the left and their north poles facing to the right. The tube magnets 24a, 24b are cylindrical or disc shaped and the tube member has a central round opening to accept the tube magnets mounted therein.

Disposed at the center of the tube segment 22 is a frame 30 having a generally rectangular opening at the top. The rectangular opening is the same size as an opening in the top of the tube member. The tube member assembly 18 has disposed therein a cylindrical driver magnet assembly 16 with a magnet 40. The assembly 16 has an upstanding paddle 42. The paddle 42 can travel longitudinally in the rectangular frame opening 32, and the driver magnet 40 can travel longitudinally the same distance.

The tube member has a wire coil 20 wound around it. The coil would preferably have many turns and wound with a mechanized winder to pack the turns tightly and in layers. The two ends 44 of the coil are shown at the ends of the tube member.

When the driver magnet 40 slides longitudinally within the tube member a current is induced in the wire coil 20 and a voltage is present across the ends 44 of the coil. Of course, the thickness of the coil wire and number of turns, as well as the size of the tube member assembly may be designed for the particular application, and the current and voltage desired. Also, the faster the driver magnet is moved the higher the induced current and voltage.

A rocker assembly 14 provides a means to interact mechanically and magnetically with the tube assembly. The rocker assembly is designed to pivot about a pivot point in its longitudinal center. The rocker assembly has a trigger 50 extending downwardly which mechanically engages the paddle. This operation will be described in more detail below. When operated in a generator mode, mechanical travel of the driver magnet 40 by the trigger and paddle induces a current through and voltage across the coil. This energy can be used in a number of ways, one example of which is described below. When operated in a motor mode, a voltage applied across the coil will result in a current through the coil and cause the driver magnet 40 to move within the tube member, in turn causing the paddle 42 to move the trigger 50 and rocker assembly.

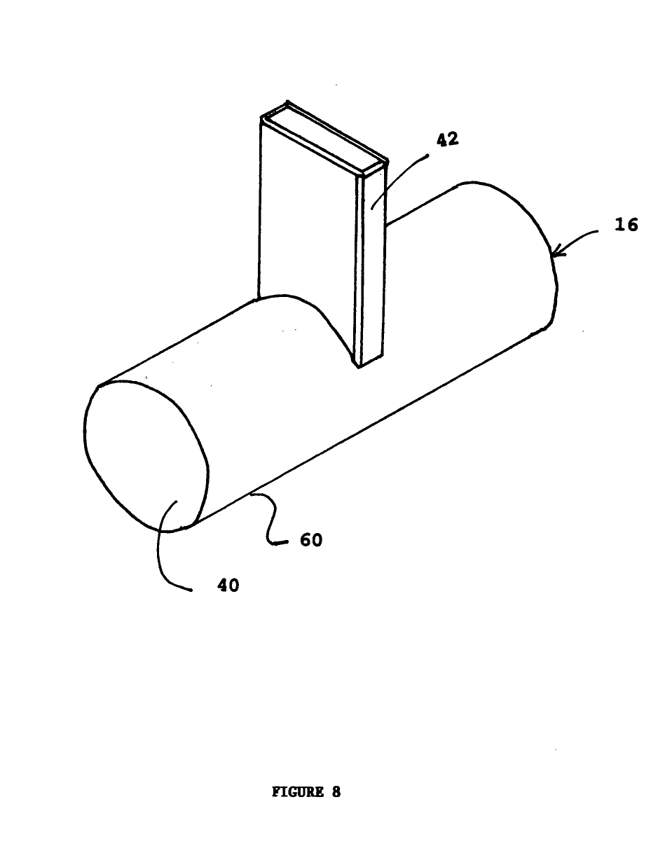

FIG. 8 shows an assembly 16 for the driver magnet 40 which is formed of a driver magnet sleeve 60 integral with a paddle 42. The sleeve and paddle may be made from plastic or Teflon from a mold or other suitable way. The driver magnet 40 is in the form of a cylinder which is inserted into the sleeve and fixed in place by glue or other means. The driver magnet assembly may be made by first placing magnetizable material into a sleeve, optionally covering the ends of the sleeve to fully enclose the magnetizable material, and then forming the sleeve-paddle unitary structure. One way would be to make a mold, into which the magnetizable material is placed and than injecting the plastic or Teflon material into the mold which will fully encapsulate the magnetizable material and form the sleeve and paddle. The magnetizable material may be magnetized after the driver magnet assembly is made.

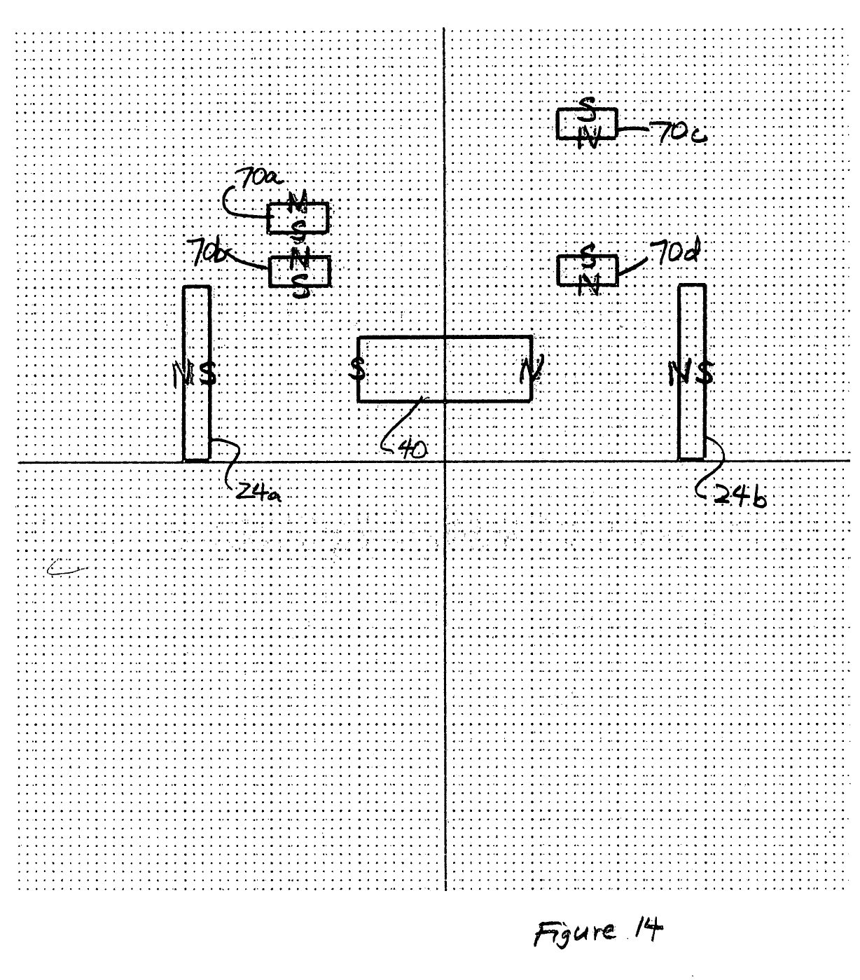

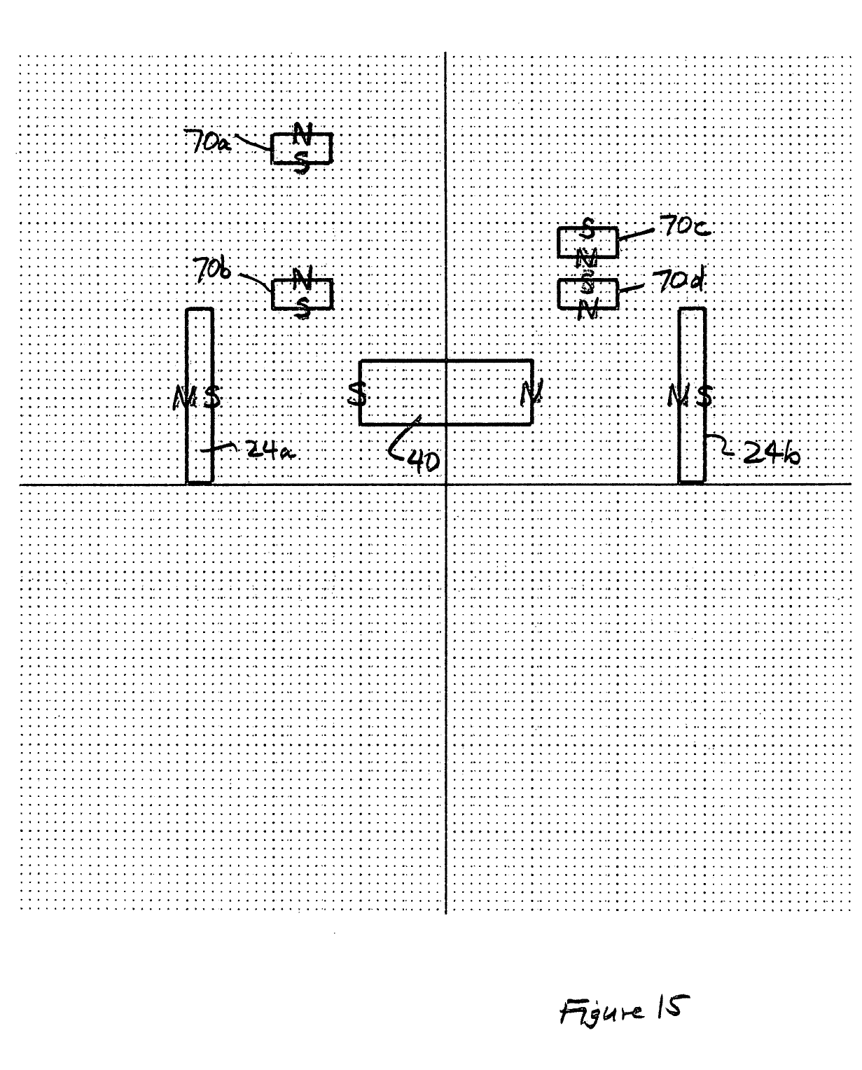

The rocker assembly has four two rocker magnets 70a and 70c and two face magnets 70b and 70d (see FIGS. 10, 14 and 15). Face Magnets 70b and 70d do not move. Rocker magnets 70a and 70c are mounted in a rocker switch 80 in receptacles 82a, 82b and are intended to move with the rocker switch between the two relative positions shown in FIGS. 14 and 15. Of course, the magnets 70c and 70d may actually be closer together than that shown in FIGS. 10 and 15, when the rocker switch is in the down right position shown in these two figures. The magnets 70a and 70b may likewise be closer together when the rocker switch is in the down left position.

The rocker will occupy one of two positions, one of which is shown in FIG. 10. When the rocker is moved from its present or first position (shown in FIG. 10) to its other or second position, the trigger 50 on the bottom of the rocker will drive the driver magnet 40 in one direction (to the right) causing the driver magnet 40 to induce a voltage across the coil. At the same time, the rocker magnet 70a which started away from its respective face magnet 70b will come closer to its respective face magnet 70b, and the face rocker 70d magnet 70c which started close to its respective face magnet 70d will be moved further away from its respective face magnet. The action of the rocker and face magnets with the tube magnets 24a, 24b will create magnetic forces on the driver magnet 40 causing it to induce more voltage in the wire coil than if no rocker and face magnets were present. After the rocker is moved to the other of its positions, the bottom of the trigger 50 clears the top of the paddle 42, and the driver magnet 40 will come to a rest position centered in the tube member due to the tube magnets 24a, 24b at the end of the tube. The bottom of the trigger 50 will then be positioned on the opposite side of the top of the paddle 42, ready to drive the paddle in the opposite direction when the rocker is moved back to the one first position.

The driver magnet 40 has its N and S poles in the orientation indicated in FIGS. 14 and 15. The tube magnets 24a, 24b at the end of the tube member are oriented to have their N and S poles in the direction opposite to that of the driver magnet. This arrangement causes the driver magnet 40 to be repelled by both of the tube magnets to keep it centered in the tube member, unless it is mechanically pushed off center by the paddle when the device is working in a generator mode, or when it is pulled off center by current flowing through the coil (caused by a voltage applied across the coil) when the device is working in a motor mode.

FIG. 10 shows the rocker assembly having rocker and face magnets disposed at the ends of the rocker. At each end of the rocker assembly are two magnets, an upper rocker magnet (70a or 70c) and a lower face magnet (70b or 70d). The lower face magnets are fixed in place and the upper rocker magnets are intended to be moveable between an upper position spaced from its respective face magnet, and a lower position close to and possibly in contact with its respective face magnet. (See FIGS. 14 and 15). The movement of the rocker magnets between their upper and lower positions depends on which end of the rocker assembly is in its downward position relative to the tube segment assembly. The N-S orientation of the rocker and face magnets are shown in FIGS. 14 and 15.

The four rocker and clamp magnets may be referred to as upper left, lower left, upper right and lower right. The upper left and lower left magnets are oriented from top to bottom SN and SN. The upper right and lower right are oriented from top to bottom NS and NS. The upper magnets are integral and move with a rocker surface element and the lower magnets are mounted in a rocker housing into which the rocker surface or switch element is pivotally mounted about the pivot point. The pivot point defines the axis of pivot of the rocker surface element and the rocker housing. The rocker surface element rocks between two positions in the rocker housing which will be called rocker down right and rocker down left. Movement between these two positions, when the device is operating in a generator mode, is effected by a user pressing downward on the uppermost half of the rocker surface element. If the device is mounted vertically as would be the typical case if the device is arranged as a wall switch, the user would press inward on the half of the rocker surface element which protrudes outward from the rocker housing similar to that when operating a conventional rocker power switch of the Decora type.

Movement of the rocker surface element between the two positions (rocker down right and rocker down left) creates a mechanical action between the trigger, paddle and driver magnet, as well as a magnetic action between the rocker clamp magnets and driver magnet, as will be described more fully below.

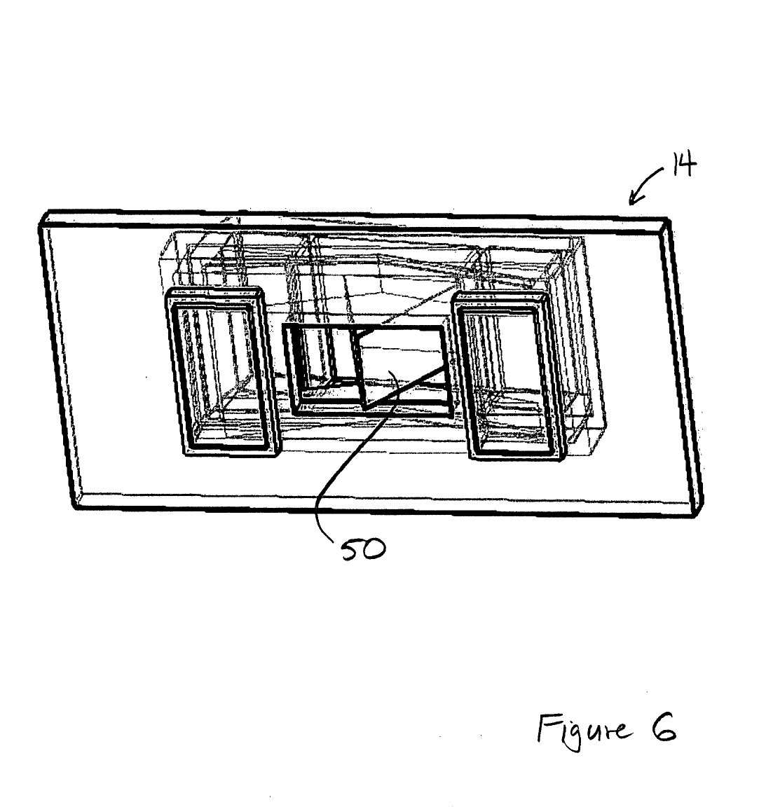

FIGS. 14 and 15 and 6B show the magnet portions of the respective assemblies. As can be seen, the rocker and clamp magnets are arranged in orientation NS, NS and SN, SN while the driver magnet is arranged in orientation NS, which keeps the driver magnet centered between the two ends without mechanical springs or other mechanical biasing elements.

FIG. 15 shows the arrangement where the rocker assembly is switched with its right side down and it's left side up, so that the top right rocker magnet 70C is close to its lower right clamp magnet 70d, and the top left rocker magnet 70a is spaced from its lower left clamp magnet 70b. FIG. 14 shows the arrangement where the rocker assembly is switched with its right side up and its left side down.

When the rocker switch goes from the rocker down right (FIG. 15) to rocker down left (FIG. 14), the top left rocker magnet 70a goes down, and the top right rocker magnet 70b goes up. The immediate effect of these rocker magnet movements is to add to the driving force of driver magnet 40 toward the right, as the N pole of the top left rocker magnet 70a will tend to oppose the N side of the driver magnet 40 and drive it off center to the right, and the S pole of the top right rocker magnet 70c will tend to lessen the opposition magnetic field on the S pole of the driver magnet 40 and also aid in the making the driver magnet 40 go to the right. Movement of the rocker from rocker down left (FIG. 14) to rocker down right (FIG. 15) will have the opposite effect.

The contributory effects of the mechanical paddle movement to one side, plus the magnetic effect of the upper rocker magnets as just described provide a movement of the driver magnet through the coil sufficient to generate a current through and voltage across the coil for a sufficient time to create energy for many applications. One such application which will be described in more detail below is to provide a signal useful for a batteryless, wireless switch.

FIG. 10, with the circuit of FIGS. 12 and 13 shows the device according to the embodiment arranged with other parts to operate in a generator mode to function as a wireless, batteryless switch controller. The device, described above, may be enclosed in a receptacle like that shown in FIG. 1 and the coil wire ends (of coil L1 of FIG. 12) are connected to a circuit board, the circuit board being located in the bottom of the receptacle. The circuit board has circuitry to generate and transmit through the antenna, in response to a voltage being produced at the coil wire ends, a switching signal. The switching signal is used in conjunction with a receiver of FIG. 13 which receives the transmitted signal, decodes the switching signal and uses it to operate an electrical device. One such example is control of a light fixture in a room. The switch device may be a rocker switch like the prevalent rocker switches used in residential and commercial electrical systems to operate a light. The rocker switch may be sized to fit into a standard electrical switch box. The rocker switch may be sized and shaped differently for different national or regional markets. For example, in the United States, a common rocker switch is sold under the trade name or trademark Decora. In Europe, like switches are also available which are believed to be smaller in size than the U.S. switches.

The switch device can be simply mechanically mounted in an electrical switch box and no power source need be connected such as batteries or 110 VAC power.

To control a light in a room, a receiver is mounted in a series connection between the hot (or black wire) of the 110 VAC power and either completes or opens the electrical path to turn on or off the light.

When used as described for a batteryless, wireless switch controller, no batteries are needed and no power or switch lines need to be connected to the receptacle box which houses the switch controller. The switch controller may be used in original and retrofit applications, saving the cost and inconvenience of running wires to the switch receptacle box.

The switch controller may be provided with a coding setting devices such as DIP switches similar to the coding setting devices for remote control garage door openers and the like. In this way the switch controller will operate only the light or other electrical device for which it was intended and many may be used in the same room or premises, each having a different code setting. The receivers will be set to the same code as the transmitter.

It is possible to use the same switch controller for a number of different lights or electrical devices by having a code setting device on the switch controller accessible to the user.

While one preferred embodiment has been described, the present invention is not limited to the embodiment illustrated and described, and the scope of the invention is determined by reference to the appended claims.

I claim:

1. An electromotive device operable as a motor/generator for converting energy between a mechanical form and an electrical form, comprising:
a tube member having a hollow center, and having a driver magnet slideable within the hollow center, said tube member having and opening generally in the center of the tube member;
a paddle connected to the driver magnet and extending through the opening in the tube member, a wire coil wound along at least part of the length of the tube member and having two coil ends;
first and second tube magnets, each tube magnet mounted near a different end of the tube member, said driver magnet and tube magnets oriented in their magnet fields to oppose the driver magnet from the ends of the tube member;
a rocker having a pivot point and first and second ends, and having a first rocker magnet at the first end of the assembly and a second rocker magnet at the second end of the assembly, said rocker adapted to pivot about a pivot point between a first position wherein the first rocker magnet is positioned closer to the tube member, and a second position wherein the second rocker magnet is positioned closer to the tube member, wherein during pivot movement between the first and second positions, the driver magnet slides within the tube, by engagement of the paddle with the rocker assembly and by magnetic forces between the driver magnet and clamp magnets;
wherein the device is operable as a generator for generating a voltage across the two coil ends when the rocker is moved between the first and second positions, and wherein the device is operable as a motor for moving the rocker between first and second position when a voltage is applied across the two coil ends.

2. The device according to claim 1, wherein the rocker assembly comprises a rocker housing with a lower left clamp magnet and a lower right clamp magnet, and a rocker element adapted to pivot with respect to the rocker housing and having an upper left rocker magnet and a upper right magnet, said upper left rocker magnet positioned closer to the first tube magnet when the rocker element is in a second position.

3. The device according to claim 1, wherein the device includes a circuit connected to the ends of the coil for generating and transmitting a switching signal in response to a sufficient voltage appearing across the coil and a current flowing through the coil.

4. The device according to claim 1, further including a receiver circuit adapted to receive the switching signal and for operating a switch.

5. An electromotive device operable as a motor/generator for converting energy between a mechanical form and an electrical form, comprising:
a tube member having a hollow center, and having a driver magnet slideable within the hollow center, said tube member having and opening generally in the center of the tube member;
a paddle connected to the driver magnet and extending through the opening in the tube member,
a wire coil wound along the length of the tube member and having two coil ends;
first and second tube magnets, each tube magnet mounted on a different end of the tube member, said driver magnet and tube magnets oriented in their magnet fields to oppose the driver magnet from the ends of the tube member;
a rocker having a pivot point and first and second ends, and having a first rocker magnet at the first end of the assembly and a rocker clamp magnet at the second end of the assembly, said rocker adapted to pivot about a pivot point between a first position wherein the first rocker magnet is positioned closer to the tube member, and a second position wherein the second rocker magnet is positioned closer to the tube member, wherein during pivot movement between the first and second positions, the driver magnet slides within the tube, by engagement of the paddle with the rocker assembly by magnetic forces between the driver magnet and rocker magnets;
wherein the device is operable as a generator for generating a voltage across the two coil ends when the rocker moves between the first and second positions, and wherein the device is operable as a motor for moving the rocker between first and second position when a voltage is applied across the two coil ends;
wherein the rocker assembly comprises a rocker housing with a lower left clamp magnet and a lower right clamp magnet, and a rocker element adapted to pivot with respect to the rocker housing and having an upper left rocker magnet and a upper right rocker magnet, said upper left rocker magnet positioned closer to the first tube magnet when the rocker element is in a second position; and
wherein the device includes a circuit connected to the ends of the coil for generating and transmitting a switching signal in response to a sufficient voltage appearing across the coil and a current flowing through the coil.

6. The device according to claim 5, further including a receiver circuit adapted to receive the switching signal and for operating a switch.

7. An electromotive device for converting energy from a mechanical form to an electrical form comprising:
an electrical coil having two ends;
a driver magnet moveable within the electrical coil;
means for mechanically moving the driver magnet relative to the electrical coil;
means for magnetically moving the driver magnet relative to the electrical coil;
said means for mechanically moving and means for magnetically moving the driver magnet combining to move the driver magnet relative to the electrical coil in the same direction at the same time.
